(19) United States
(12) Patent Application Publication
(10) Pub. No.: US 2009/0320940 A1
(43) Pub. Date: Dec. 31, 2009

(54) CONNECTOR CLAMP WITH PRESSURE VALVE

(75) Inventors: Andreas Hilgert, Sinzheim (DE); Thomas Zeon Zakrzewski, Rastatt (DE); Ralph Peter Merkel, Rastatt (DE); Markua Angelo Ullrich, Baden-Baden (DE)

Correspondence Address: DYKEMA GOSSETT PLLC, 39577 WOODWARD AVENUE, SUITE 300, BLOOMFIELD HILLS, MI, 48304-5086, US

(73) Assignee: EATON FLUID POWER GMBH, Baden-Baden (DE)

(21) Appl. No.: 12/300,155

(22) PCT Filed: Jul. 29, 2006
(86) PCT No.: PCT/EP2006/007537

§ 371 Date: Apr. 16, 2009

(30) Foreign Application Priority Data
May 10, 2006 (DE) 10 2006 021 709.8

(51) Int. Cl. F16K 17/04; F16K 17/02

(52) U.S. Cl. 137/537

(57) ABSTRACT

A connecting device for a hydraulic system is provided. In an embodiment, the device includes a valve provided in a passage channel that can be configured to switch flow based on a pressure differential between passage channel pressure and ambient pressure. In an embodiment, the connecting device may include a valve housing provided in the form of a bolt, and the valve housing may be configured for connection to an assembly unit.

The invention relates to a connecting device for hydraulic systems.

As a rule, hydraulic systems comprise several assembly units such as, for example, pumps, actuators, dampers, filters, setting members and the like, these being connected to each other by means of lines. In so doing, it may happen that valves become necessary, said valves being controlled by the prevailing pressure in the hydraulic system, for example, in that they are opened or closed. Such valves are provided, e.g., as separate assembly units.

Regarding this, document DE 103 25 202 A1 discloses such a valve with its own housing and an input connection as well as an output connection. Inside the housing, a stepped piston is supported so that it can be slid against the force of a spring that acts as the valve slide. It clears or blocks the valve passage. In so doing, various dampers arranged in a system between a pump and a load can be switched to be active or passive.

Similarly, U.S. Pat. No. 4,310,140 discloses a pressure-controlled valve in a housing, three connections provided on the housing and a valve apparatus arranged inside the housing.

It has been known from document DE 196 42 837 C1 to install a valve device configured as a damper valve in a housing, said valve being disposed to act, at the same time, as a connecting part for a line that is to be connected. The damper valve is controlled by the strength of the oil flow and closes when said flow exceeds a specific value. This valve is used to reduce the reverse effect of road shocks on the steering wheel of the operator of a vehicle with power-assisted steering.

In order to connect this valve to the line, a line with a ring connection is required, said ring connection having a particularly large diameter, namely one that is larger than usual. In addition, a particularly wide tapped bore must be provided at the piston/cylinder assembly unit of the power-assisted steering.

It is the object of the invention to provide a possibility for accommodating a valve device in a hydraulic system, said valve device being particularly simple and not requiring any special adaptive measures on the system.

This object is achieved with the connecting device in accordance with claim 1.

The inventive connecting device comprises a connecting bolt of conventional design size, said bolt being used to connected a line to be connect to an assembly unit. To achieve this, the connecting bolt has a passage channel. Inside the connecting bolt is a valve device which can affect the flow in the passage channel and is controlled by the pressure differential between the prevailing pressure in the passage channel and the ambient pressure (i.e., usually the atmospheric pressure). Thus, the pressure-controlled valve may be mounted to each desired assembly unit in that the special connecting bolt provided with the valve device is used instead of a conventional connecting bolt. To achieve this, modifications are required neither on the assembly unit nor on the line to be connected. In addition, this solution of the technical problem does not require any additional design space for the pressure-controlled valve device. The connecting bolt has a seat for the line that is to be connected. Preferably, this is a seat for a so-called ring piece connector or banjo connector. In so doing, the connecting bolt and the ring piece connector are adapted to each other regarding their size. For example, the connecting bolt has an outside diameter of 12 mm, 14 mm or 16 mm. The cylindrical surface intended as the seat for the line connection between the head and the thread has approximately the same length in axial direction, i.e., 12 mm, 14 mm or 16 mm. Overall, the length of the bolt in axial direction is clearly greater than said bolt's diameter. Preferably, the bolt is provided with a standard thread which, in addition, fits the threads on the assembly units on corresponding tapped pocket bores for fluid connection, said threads being already present, for example, M8, M10, M10×1, M12, M14×1.5, M16×1.5, or even with a standard thread in terms of another thread standard. The advantage of this measure consists in that the connecting device in accordance with the invention may replace existing connecting bolts without modification of the system.

Preferably, the connecting bolt has a hexagonal head with a width that is clearly greater than the diameter of the remaining body of the connecting bolt. To this extent, the connecting bolt has the form of a conventional screw. Its central passage channel preferably has at least one radially branching off section that terminates in an outside surface of the connecting bolt. Thus, ring-shaped ring connectors of lines may be used for fluid connection.

Preferably, the valve device is designed as a throttle valve. In a first position, this valve may adopt a low flow resistance and, in a second position, a higher flow resistance. In many application situations it is advantageous if the valve device displays a low flow resistance at low system pressure and a high flow resistance at high system pressure. Preferably, the transition is stepwise, whereby the switching threshold or the threshold itself may be varied by biasing a compression spring and by appropriately selecting the cross-section of the sealing piston. In so doing, the connecting device may be used at the input of a valve block of a power-assisted steering system, where said device generates a low flow resistance when driving straight and a high flow resistance when driving through curves. This prevents pulsations that may originate from the hydraulic pump of the system from reaching the steering wheel or the driver. On the other hand, the energy-draining high flow resistance is generated only when driving through curves but not when driving straight forward.

The connecting device in accordance with the invention, however, can also be provided on other hydraulic systems such as a hydraulic or electrohydraulic active running gear control and/or similar systems.

The valve device may comprise a sliding valve and/or a seat valve. In principle, it is possible to allow them to operate so as to be pressure-controlled independently of each other. However, it is preferred that both valves belonging to the valve device be preferably rigidly connected to each other in order to adjust them together, for example, against the bias of a compression spring. An extension—that is cylindrical, for example—projects from the connecting bolt in a sealed and axially shiftable manner so that the ambient pressure acts on said connecting bolt's outer end side and the system pressure acts on said bolt's inner end. The resultant pressure differential causes the valve slide to shift. Preferably, the compression spring is pretensioned so that a shifting of the valve slide or of the valve closure member occurs only when said pressure differential exceeds a limiting value. Thus, the valve device can be imparted with a reversing characteristic that displays a more or less pronounced hysteresis.

Additional details of advantageous embodiments of the invention are the subject matter of the drawings, the description or the claims.

The drawings represent exemplary embodiments of the invention. They show in

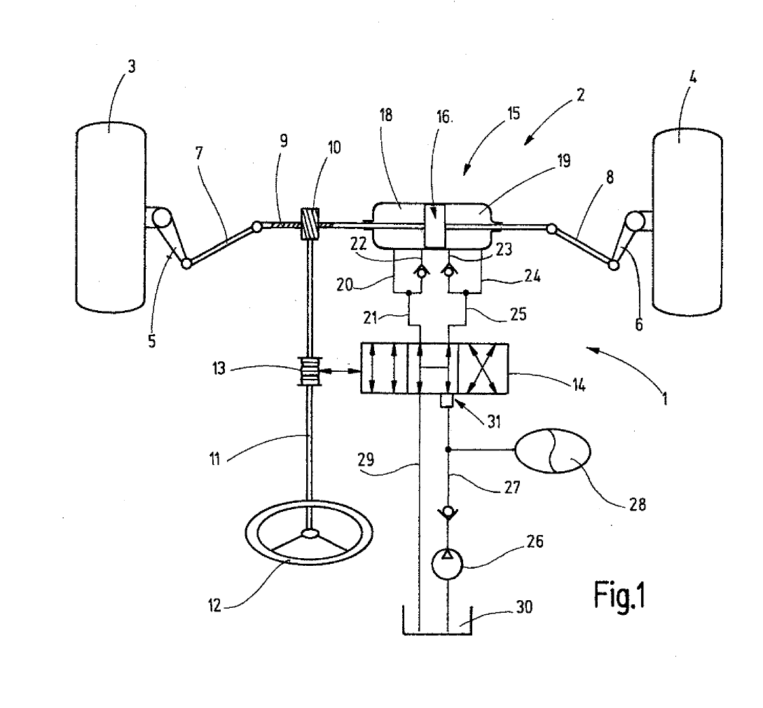

FIG. 1 a schematic illustration of a hydraulic power-assisted steering system comprising the connecting device in accordance with the invention;

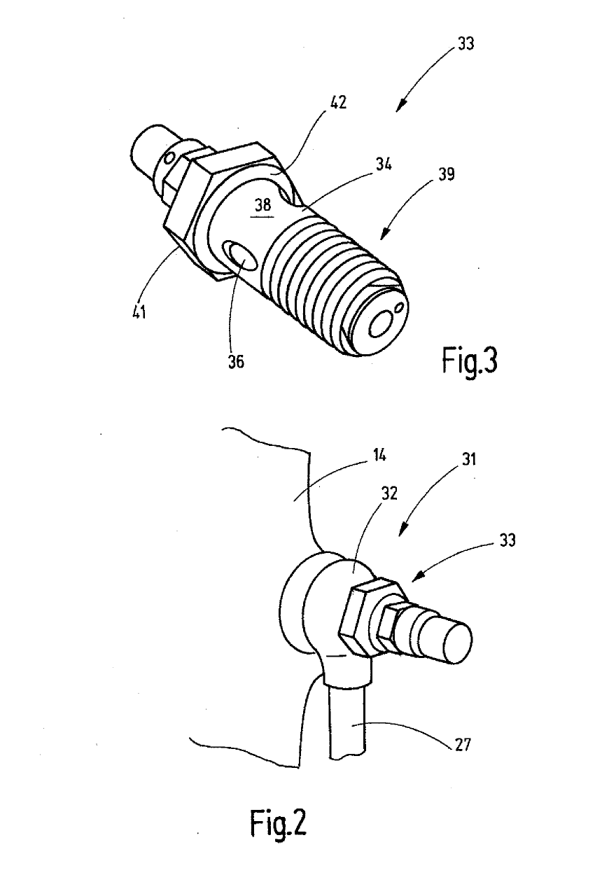

FIG. 2 a physical perspective view of the outside of a connecting device of the system in accordance with FIG. 1;

FIG. 3 a separate perspective representation of a connecting bolt of the connecting device in accordance with FIG. 2;

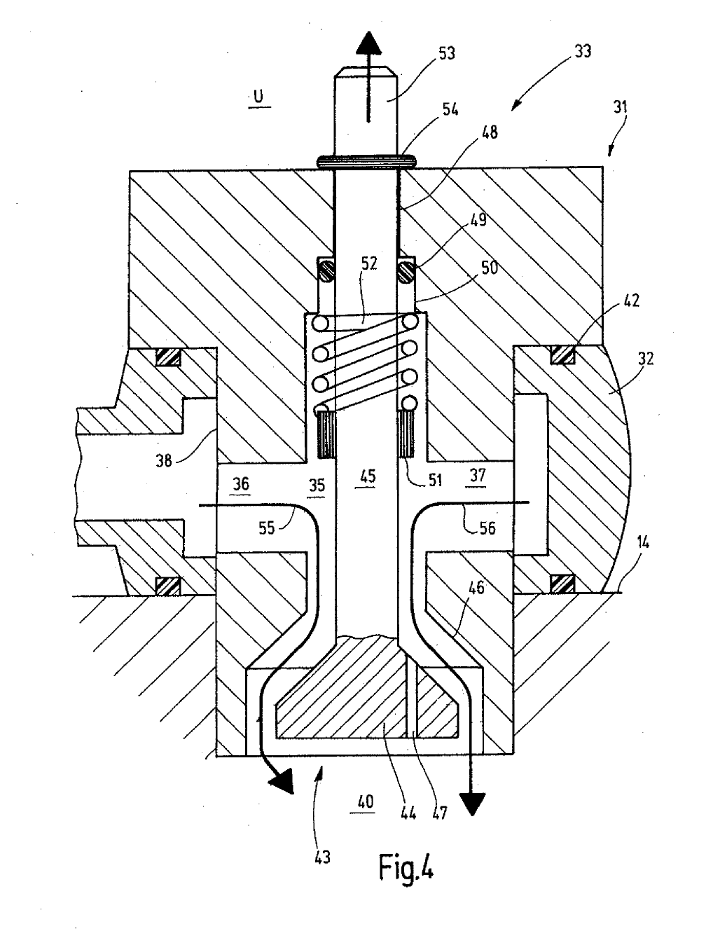

FIG. 4 a view, longitudinally in section, of the connecting device in accordance with FIG. 2, with the valve in open position;

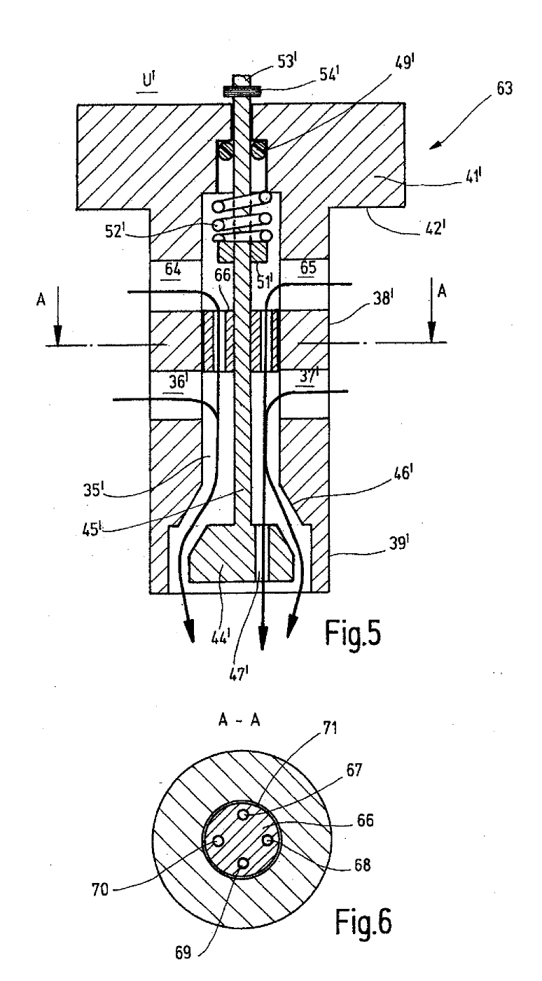

FIG. 5 a view, longitudinally in section, of a modified embodiment of a connecting device in accordance with the invention, with the seat valve and the sliding valve;

FIG. 6 a sectional view, along line A-A, of the connecting device in accordance with FIG. 5;

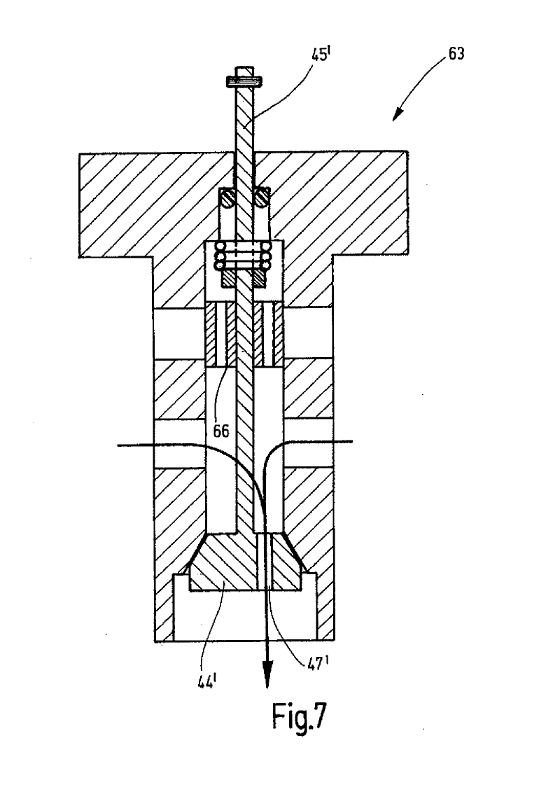

FIG. 7 the connecting device in accordance with FIG. 5, with the valve device in closed position;

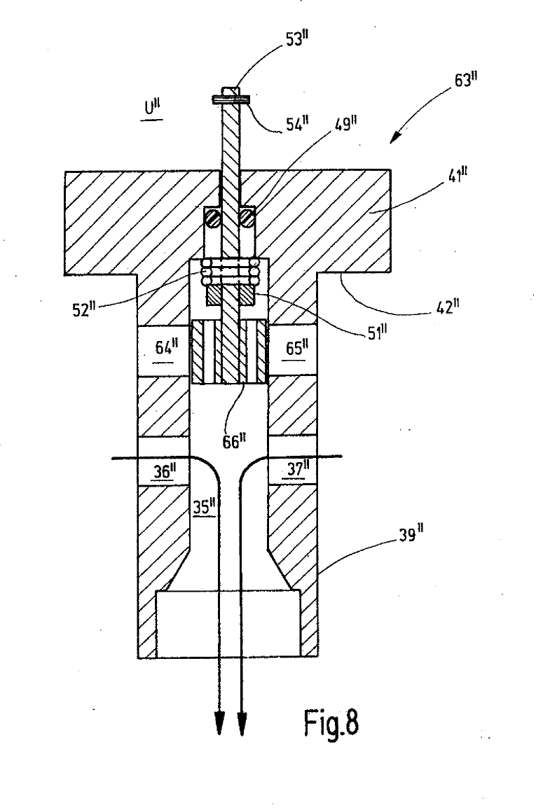

FIG. 8 a schematic view, longitudinally in section, of a modified embodiment of the connecting device, with the valve device configured as a sliding valve;

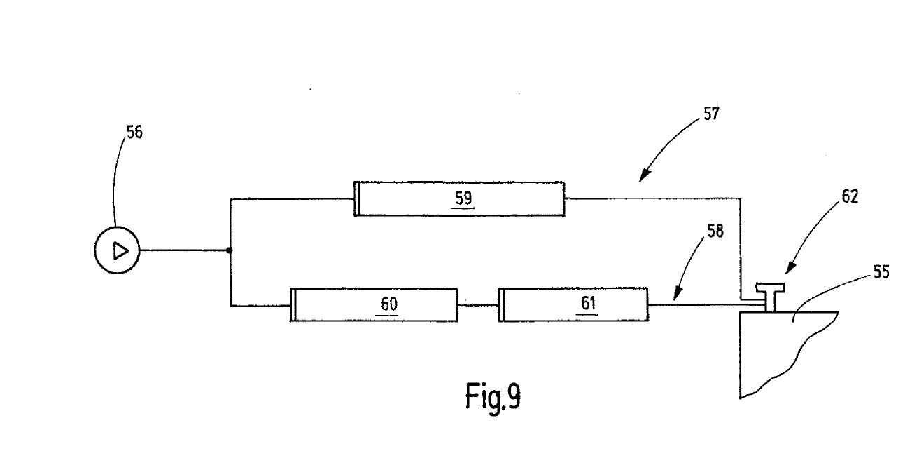

FIG. 9 a schematic representation of a hydraulic system with alternative branches and with the switching valve in the connecting device;

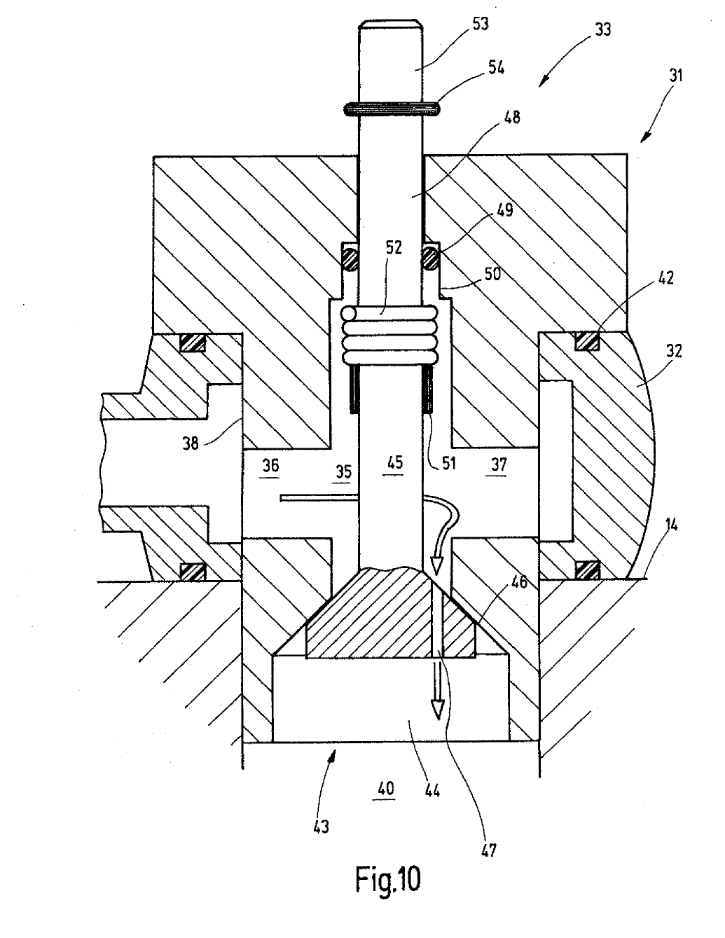

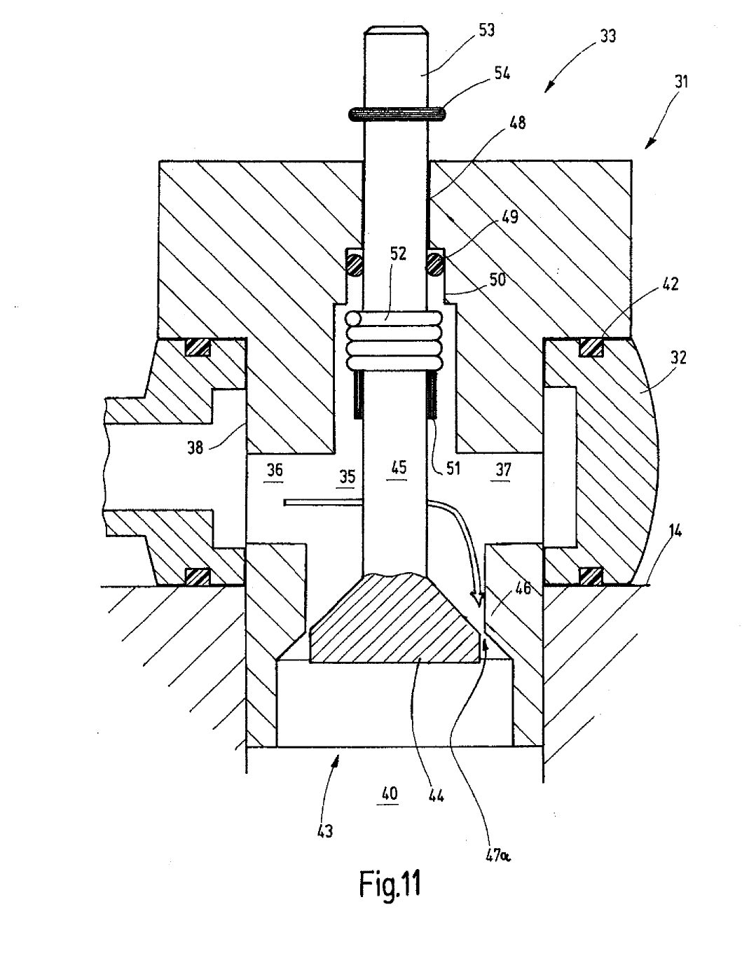

FIG. 10 a view, longitudinally in section, of the connecting device in accordance with FIG. 2, with the valve in closed position;

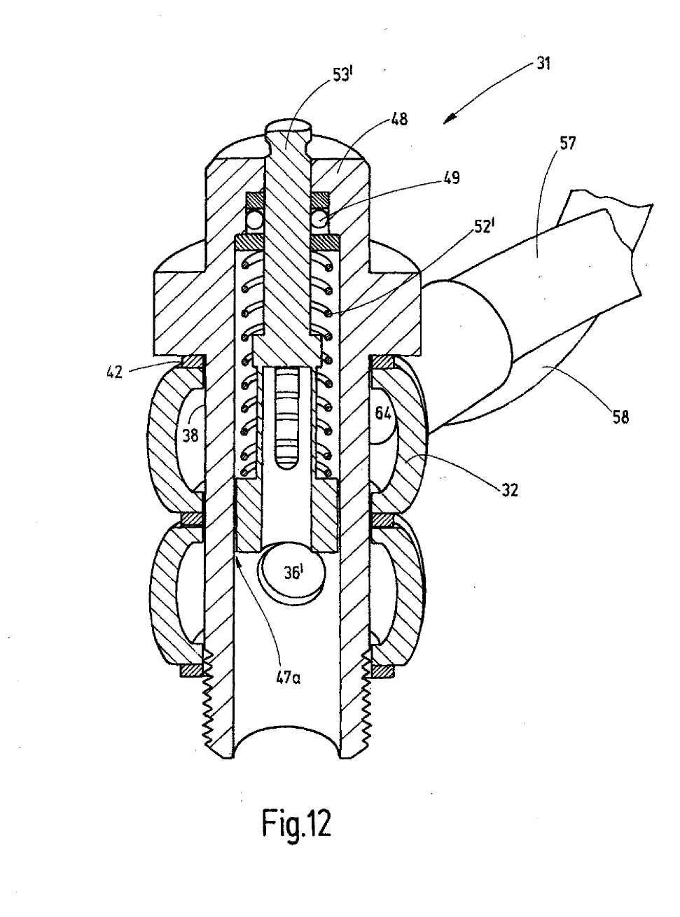

FIG. 11 a view, longitudinally in section, of a modified connecting device in accordance with FIG. 10, with the valve during its transition into the closed position; and,

FIG. 12 a view, longitudinally in section, of another modified connecting device for two line connections.

FIG. 1 shows a power-assisted steering system 2 of a motor vehicle as the example of a hydraulic system 1. This system is disposed to steer two wheels 3, 4 via the steering arms 5, 6 by means of tie rods 7, 8 that are connected to a steering rack 9. The latter meshes with a pinion 10 that is actuated by a steering column 11 by way of a steering wheel 12. A torsionally flexible element 13 located upstream of the pinion 10 actuates a servo valve 14 in order to control a power-assisted drive 15. The steering rack 9, the pinion 10, the torsionally flexible element 13, the servo valve 14 and the power-assisted drive 15 can be accommodated together in one housing. The power-assisted drive 15 comprises a piston 16 that assists the steering motion of the steering rack 9 and divides two working chambers 18, 19 in a cylinder 17. These are connected, via lines or channels 20 through 25, to the servo valve 14. Via line 27, hydraulic fluid is supplied to the servo valve 14 by a hydraulic pump 26, whereby a buffer 28 branches off said line. Via a line 29, the servo valve 14 returns hydraulic fluid to a collector 30. The line 27 is connected to the servo valve 14 via a connecting device 31 which contains a valve device as will be explained later.

The hydraulic pump 26 displays an essentially constant discharge rate, i.e., it conveys a constant volume flow, potentially as a function of the rate of revolutions of the engine. When driving straight forward, this volume flow occurs without the build-up of pressure via the line 27 to the servo valve 14 and via the line 29 back into the reservoir 30. The servo valve 14 is in its central position. When driving through curves, however, the hydraulic fluid is directed to the power-assisted drive 15 that does not allow an unimpaired discharge of the hydraulic fluid. Consequently, considerable pressure is built up. In this state, it is desirable to damp the pressure pulsations originating from the hydraulic pump 26 so that they will not be felt in the steering wheel 12 and do not lead to undesirable noise in the passenger compartment. This is made possible by the connecting device 31 that is separately illustrated by FIGS. 2 through 4. FIG. 2 shows the housing of the servo valve 14 as well as, optionally, additional assembly units as previously explained. The connecting device 31 comprises a ring-shaped line connecting eye 32 that is also referred to as a ring piece connector. It comprises a connecting bolt 33 that is separately shown in FIG. 3.

The connecting bolt 33 has an essentially cylindrical body 34 through which extends—in axial direction—a passage channel 35, as is obvious from FIG. 4. At least two, preferably several, radial sections 36, 37 branch off this channel and terminate at the cylindrical lateral surface 38 of the connecting bolt 33. Below the lateral surface 38 there is a thread 39 that matches an already existing connecting bore thread in the servo valve 14. The thread of the connecting bore represents a connection to a channel 40 in the assembly unit or in the servo valve 14.

As is shown by FIG. 3, the connecting bolt 33 preferably has a hexagonal head 41 that has, on its side facing the thread 39 or the servo valve 14, an annular surface 42 configured as a sealing surface, whereby the line connecting eye 32 is in sealing abutment with said annular surface. On the opposite side, the line connecting eye 32 provides a seal on the housing of the servo valve 14.

Seated in the passage channel 35 of the connecting bolt 33 is a valve device 43 that is disposed to vary the flow resistance of the hydraulic fluid from the line 27 into the channel 40. The valve device 43 has a valve closure member 44 configured as a valve cone that is held on a pin-like extension 45. The valve closure member 44 is associated with an, e.g., a conical valve seat 46, against which it can abut in a sealing manner. As illustrated, the valve closure member 44 may be provided with one or more throttling ports 47 that are able to bridge the closed valve.

As also shown by FIG. 10, the extension 45 projects from the connecting bolt 33 through an opening 48. Preferably, the opening 48 is a cylindrical central bore in which the extension 45 is guided with minimal play. An O-ring 49 or another suitable sealing means seals the ring space between a wall 50—enclosing the extension 45 with play—and the extension 45.

Furthermore, a backup ring 51 may be provided on the extension 45, whereby a compression spring 52 abuts against said ring, said ring's other end abutting against a corresponding inside shoulder of the connecting bolt 33. The compression spring biases the valve closure member 44 away from its valve seat. At the end 53 of the extension 45 projecting from the connecting bolt 33, an abutment is provided that is configured, for example, as an angled pin 54 that retains the compression spring 52 in biased state.

As is shown by the alternative in accordance with FIG. 11, the throttle cross-section can be formed not only the channel 47 but also by a throttle gap 47a that is delimited by one wall of the valve closure member and that has a width that is a function of the axial position of the valve closure member. Also, the outside circumference of the valve closure member 44 may be provided with grooves or other passage cross-sections in order to produce the desired throttle cross-section and pressure gradient. Other than that, the above description applies to FIG. 11, whereby the introduced reference numbers apply accordingly.

The connecting device 31 described so far operates in the hydraulic system as follows:

When driving straight forward, when the servo valve 14 creates a short circuit between the lines 27 and 29, the system pressure is low on the connecting device 31 at a given pump delivery. As indicated by the arrows 55, 56 in FIG. 4, the hydraulic fluid may flow freely out of the line 27 into the servo valve 14. Only minimal flow losses occur. The power input of the hydraulic pump 26 is minimal.

If the vehicle is being steered, the bypass or short circuit between the lines 27, 29 is eliminated and the system pressure increases. In so doing, the system pressure acts on the valve closure 44 and attempts to push it against the valve seat 46. The contact surface effective for the pressure, in so doing, is the cross-sectional surface of the extension 45, whereby only the minimal ambient pressure U acts on the cross-sectional surface. As soon as the pressure differential exceeds the force of the compression spring 52, the valve begins to close. Then, only the throttle bore 47 is still open, it being configured as a bore hole in this case. The throttle effect ensures that, when pressure is applied, no undesirable noise is produced.

If the system pressure drops again because the driver steers into straight forward position, the compression spring 52 effects an opening of the valve. The valve closure member 44 again lifts off the valve seat 46 and allows an almost unhindered hydraulic flow.

FIGS. 5 through 7 illustrate a modified embodiment of the connecting bolt 33 as can be used for the connection of various dampers, for example, in accordance with the application of FIG. 9. The system in accordance with FIG. 9, in turn, may be a steering system or also another hydraulic system. The assembly unit 55 is alternatively supplied by a hydraulic pump 56 via two parallel branches 57, 58 containing various dampers 59, 60, 61. The connecting device 62 joins the lines of the two branches 57, 58 and, in so doing, achieves a switching function. The latter essentially consists of a connecting bolt 63 in accordance with FIG. 5. To the extent that the individual features or properties of this connecting bolt correspond to that of the connecting bolt 33 in accordance with FIG. 4, the same reference numbers are used with an apostrophe for differentiation. Regarding this, reference is accordingly made to the previous description. The following is considered supplementary:

Above the sections 36′, 37′, the passage channel 35 branches again into the sections 64, 65 that also terminate at the cylindrical lateral surface 38′. The extension 45′ supports a slider 66 that cannot be shifted in axial direction and is provided with one or more axial bores 67 through 70 (FIG. 6) and is arranged in the essentially cylindrical passage channel 35′ with minimal play, thus forming a narrow gap 71. The axial bores 67 through 70 do not represent any substantial flow resistance. Instead of the depicted axial bore, it is also possible to use other throttle channels such as annular gaps, grooves or the like.

This valve operates as follows:

FIG. 5 illustrates said valve in open position. Any flow arriving through the branch 57, as well as through the branch 58, has largely been cleared. The dampers 59 through 61 are perfused relatively slowly and generate minimal flow resistance values. The system can be operated in an extremely energy-efficient manner.

When the system pressure increases, the valve reaches the position in accordance with FIG. 7. The seat vale formed by the valve closure member 44′ and the sliding valve formed by the slide 66 are closed. No appreciable hydraulic flow may occur in the branch 57. The hydraulic flow input through the branch 58 can occur only through the throttle bore 47′ or another throttle cross-section. The system operates at high damping values.

Additional modifications are possible. In conjunction with this, FIG. 8 shows a connecting bolt 63′ which, to the extent that its function corresponds to that of the connecting bolt 63 in accordance with FIGS. 5 through 7, has the same reference numbers with two apostrophes for differentiation. Accordingly, reference is made to the previous description. Different from the previously described connecting bolt 63, the connecting bolt 63″, however, does not have a seat valve. There is only the slide 66″. It is shown in its closed position that it assumes at high system pressure. In so doing, it closes the sections 64″, 65″ of the closing bolt 63″ and thus the channel 57, while the channel 58 (sections 36″, 37″) remains open. At low system pressure, both channels 57, 58 are clear.

FIG. 12 illustrates a modification of the valve in accordance with the invention. The previous description applies, whereby the reference numbers introduced and used apply accordingly. The closing piston is designed in such a manner that it—with increasing pressure and corresponding shifting—throttles the channel 58 and leaves open the channel 57. The throttle gap 47a may be narrow or wide, depending on the size of the fluid flow desired in the channel 57 at high pressure and against the force of the spring 52′ with the shifted piston.

Additional modifications are possible, whereby individual slides and seat valves work alternately in order to cause the switching effects. In addition, express reference is made to the fact that each and every previously described valve arrangement—as shown and described—can be built into the connecting bolt 33, 63, 63==, as well as also into a separated housing. The valve arrangement in accordance with one or more of the previously described embodiments may, e.g., be an integral part of a connecting block that may be located at any point of the hydraulic system. Said connecting block may, e.g., be flanged to another apparatus or be separately provided and connected via lines.

A connecting device 31 comprises a pressure-actuated valve with which the flow resistance of the connecting device can be switched between at least two values as a function of the system pressure. The connecting device is represented by a connecting bolt that is conventional from the viewpoint of its external dimensions, said connecting bolt being suitable for the connection of conventional line connecting eyes 32 to conventional threaded bores of assembly units.

1.-20. (canceled)

21. A connecting device for a hydraulic system comprising:
a connecting bolt configured for connection to an assembly unit, the bolt including:
a body;
a passage channel that extends through the body;
a valve device provided in the passage channel, the valve device configured to be controlled by a pressure differential between the prevailing pressure in the passage channel and ambient pressure;
a seat provided on the connecting bold and configured for connection to a line; and
a means for connecting the connecting bolt to said assembly unit,
wherein the passage channel is configured for connection to a fluid channel provided in said assembly unit.

22. The connecting device in accordance with claim 21, wherein the valve housing is configured as a connecting bolt.

23. The connecting device in accordance with claim 21, wherein the connecting bolt includes a hexagonal head having a width that is greater than the diameter of the remaining body of the connecting bolt.

24. The connecting device in accordance with claim 21, wherein the passage channel extends axially through the connecting bolt.

25. The connecting device in accordance with claim 21, wherein the passage channel includes at least one section that branches off in radial direction, the section terminating at an outer surface of the connecting bolt.

26. The connecting device in accordance with claim 21, wherein the bolt includes a head; the means for connecting includes a thread; and the seat includes an annular surface on the head of the connecting bolt, whereby the annular surface faces the thread and can be used to bias a connecting piece connected to the line against said assembly unit.

27. The connecting device in accordance with claim 21, wherein the means for connecting the connecting bolt to said assembly unit includes an outer thread.

28. The connecting device in accordance with claim 21, wherein the valve device includes a throttle valve.

29. The connecting device in accordance with claim 21, wherein the valve device includes a spring means and is pre-tensioned in open position by the spring means.

30. The connecting device in accordance with claim 21, wherein the valve device is a slide valve with a valve slide and includes at least one associate control bore.

31. The connecting device in accordance with claim 30, wherein the valve slide is provided with at least one channel.

32. The connecting device in accordance with claim 21, wherein the valve device comprises a seat valve with a valve closure member and with an associated valve seat.

33. The connecting device in accordance with claim 32, wherein the valve closure member includes at least one throttle channel.

34. The connecting device in accordance with claim 32, wherein the valve slide and the valve closure member are rigidly connected to each other.

35. The connecting device in accordance with claim 1, wherein the valve device comprises a switching valve.

36. The connecting device in accordance with claim 32, wherein the valve slide, the valve closure member, or the valve slide and valve closure member are connected to an extension includes a portion that projects from the connecting bolt.

37. The connecting device in accordance with claim 36, wherein the valve slide or valve closure member is configured to provide a seal and is axially shiftable.

38. The connecting device in accordance with claim 1, wherein the spring means includes a compression spring.

39. The connecting device in accordance with claim 1, wherein the valve device includes a throttle valve and a spring means, the valve device configured to be pre-tensioned in open position by the spring means; and further wherein the valve device is controlled, at least in part, by a pressure differential between ambient pressure and internal pressure.

40. A valve device for hydraulic systems comprising:
a valve housing including a passage channel, the housing configured to be connected to a line and an assembly unit;
a valve device arranged in the passage channel and controlled by a pressure differential between the prevailing pressure in the passage channel and ambient,
a seat provided in the housing and configured for connection to said line; and
a means for connecting the valve housing to said assembly unit and for connecting the passage channel to a fluid channel of said assembly unit;
wherein the valve device includes a throttle valve and a spring means, the valve device being pre-tensioned in an open position by the spring means; and the valve device is controlled, at least in part, by a pressure differential between ambient pressure and the internal pressure.

41. A hydraulic device for a motor vehicle comprising:
a hydraulic pump;
a valve block and a load;
at least one line connecting the hydraulic pump to the valve block;
wherein the line is connected to the valve block by a connecting device, the connecting device comprising a connecting bolt including a body; a passage channel that extends through the body; a valve device provided in the passage channel, the valve device configured to be controlled by a pressure differential between the prevailing pressure in the passage channel and ambient pressure; a seat provided on the connecting bold and configured for connection to the line; and a means for connecting the connecting bolt to the valve block; and further wherein the passage channel is configured for connection to a fluid channel provided in the valve block.
